(19) United States
(12) Patent Application Publication
(10) Pub. No.: US 2024/0384640 A1
(43) Pub. Date: Nov. 21, 2024

(54) A METHOD AND SYSTEM FOR REMEDIATING A WELLBORE

(71) Applicant: Romolo Loren Bertani, Sydney (AU)

(72) Inventors: Romolo Lorenzo Bertani, Sydney (AU); Amir Moezzi, Sydney (AU)

(21) Appl. No.: 18/692,174

(22) PCT Filed: Sep. 15, 2022
(86) PCT No.: PCT/AU2022/051114

§ 371 Date: Mar. 14, 2024

(30) Foreign Application Priority Data
Sep. 15, 2021 (AU) 2021902977

(51) Int. Cl. E21B 43/34; E21B 43/18

(52) U.S. Cl. CPC E21B 43/34; E21B 43/18

(57) ABSTRACT

A system and method is disclosed for contaminant extraction from a contaminated region of a borehole. The system includes a production pipe extending from a surface of the earth through a water permeable layer and into an underlying production zone. A side remediation borehole is located proximate the borehole and extends through the water permeable layer towards the production zone, the side remediation borehole including a remediation pipe. A vacuum source is in fluid communication with the side remediation borehole, the vacuum source being configured to extract gaseous contaminants from the side remediation borehole and the region of the borehole.

### FIELD OF THE INVENTION

The present disclosure relates to a method and system for remediating a wellbore, particularly by extracting contaminants from a contaminated region associated with the wellbore.

### BACKGROUND OF THE INVENTION

Hydrocarbon extraction or fracking activities typically result in uncontrolled release of contaminants, such as methane (coal seam gas) or carbon dioxide gas, from a production zone. Gases or vapours that escape from the production zone may travel along gaps created in the rock surrounding the borehole (also referred to as a wellbore) or in the cement surrounding the production casing of the borehole and the surrounding rock and migrate into a water permeable layer, potentially contaminating water supplies. These contaminant gases and vapours may also escape from the production zone over time and migrate through these gaps, ultimately being released into the atmosphere and potentially contributing to greenhouse gas emissions. It is also difficult or impossible to fix the leak of contaminants as they occur below the surface and on the outside of the casing of the wellbore. It is also possible that the casing or the cement of the wellbore may fail over time as a result of structural or chemical failure resulting in leaks through the casing.

It is desirable to reduce or minimise contamination of a water permeable layer. It is also desirable to capture the contaminants to reduce or minimise the leakage of greenhouse gases released into the atmosphere from the wellbore.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

According to one aspect of the invention, there is provided a system for contaminant extraction from a contaminated region of a borehole including a production pipe extending from a surface of the earth through a water permeable layer and into an underlying production zone, the system comprising: a side remediation borehole located proximate the borehole and extending through the water permeable layer towards the production zone, the side remediation borehole including a remediation pipe; and a vacuum source in fluid communication with the side remediation borehole, the vacuum source being configured to extract gaseous contaminants from the side remediation borehole and the region of the borehole.

The system may further comprise an outlet of the remediation pipe that is in direct or indirect fluid communication with an outlet pipe of the production pipe to combine the gaseous contaminants with gases extracted from the production pipe for downstream filtering and/or processing. The remediation pipe may include a lowermost funnel for directing gaseous contaminants migrating from the production zone towards the remediation pipe.

The system may further comprise a gas filtration assembly in fluid communication with the side remediation borehole and configured to filter gaseous contaminants extracted from the side remediation borehole and the region of the borehole. The gas filtration assembly may include a series of gaseous contaminant filter modules providing multi-stage filtering. The series of gaseous contaminant filter modules may be arranged in two or more releasably connected filter banks. The multi-stage filtering provided by the series of gaseous contaminant filter modules may involve four filtration stages. The gas filtration assembly may also be located in a relocatable container. The relocatable container is coupled to a lifting and lowering system for lifting and lowering the relocatable container from, or into, a subsurface pit.

The system may further include a filtered gas storage system in fluid communication with a filtered gas outlet from the gas filtration assembly.

The vacuum source may comprise a venturi pump driven by gases from the production pipe.

According to another aspect of the invention, there is provided a method for contaminant extraction from a contaminated region of a borehole including a production pipe extending from a surface of the earth through a water permeable layer and into an underlying production zone, the method comprising: providing a side remediation borehole located proximate the borehole and extending through the water permeable layer towards the production zone, the side remediation borehole including a remediation pipe; coupling a vacuum source to the side remediation borehole, the vacuum source being configured to extract gaseous contaminants from the side remediation borehole and the region of the borehole.

The method may further comprise extracting gaseous contaminants from an outlet of the remediation pipe that is in direct or indirect fluid communication with an outlet pipe of the production pipe to combine the gaseous contaminants with gases extracted from the production pipe for downstream filtering and/or processing. The remediation pipe may include a lowermost funnel for directing gaseous contaminants migrating from the production zone towards the remediation pipe.

The method may further comprise extracting the gaseous contaminants through a gas filtration assembly in fluid communication with the side remediation borehole and the vacuum source, wherein the gas filtration assembly is configured to filter gaseous contaminants extracted from the side remediation borehole and the region of the borehole. The gas filtration assembly may include a series of gaseous contaminant filter modules providing multi-stage filtering. The series of gaseous contaminants may be arranged in two or more releasably connected filter banks. The multi-stage filtering provided by the series of gaseous contaminant filter modules may involve four filtration stages. The gas filtration assembly may also be located in a relocatable container.

The method may further comprise coupling a filtered gas storage system to a filtered gas outlet from the gas filtration assembly.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 illustrates a perspective view of a system for remediating a wellbore in accordance with an embodiment;

FIG. 2 is an enlarged view of Insert A of FIG. 1;

FIG. 3 illustrates a perspective view of a filter assembly for filtering contaminants extracted from the remediation borehole shown in FIGS. 1-2 in accordance with an embodiment;

FIG. 4 illustrates a partial perspective view of the filter assembly of FIG. 3;

FIG. 5 illustrates a cross sectional view of the filter assembly of FIGS. 3-4;

FIG. 6 is a flowchart of a method of operating the system shown in FIGS. 1-5;

FIG. 7a illustrates a perspective view of a system for remediating a wellbore in accordance with another embodiment; and

FIG. 7b is an enlarged view of Insert B of FIG. 7a.

### DETAILED DESCRIPTION OF THE EMBODIMENTS

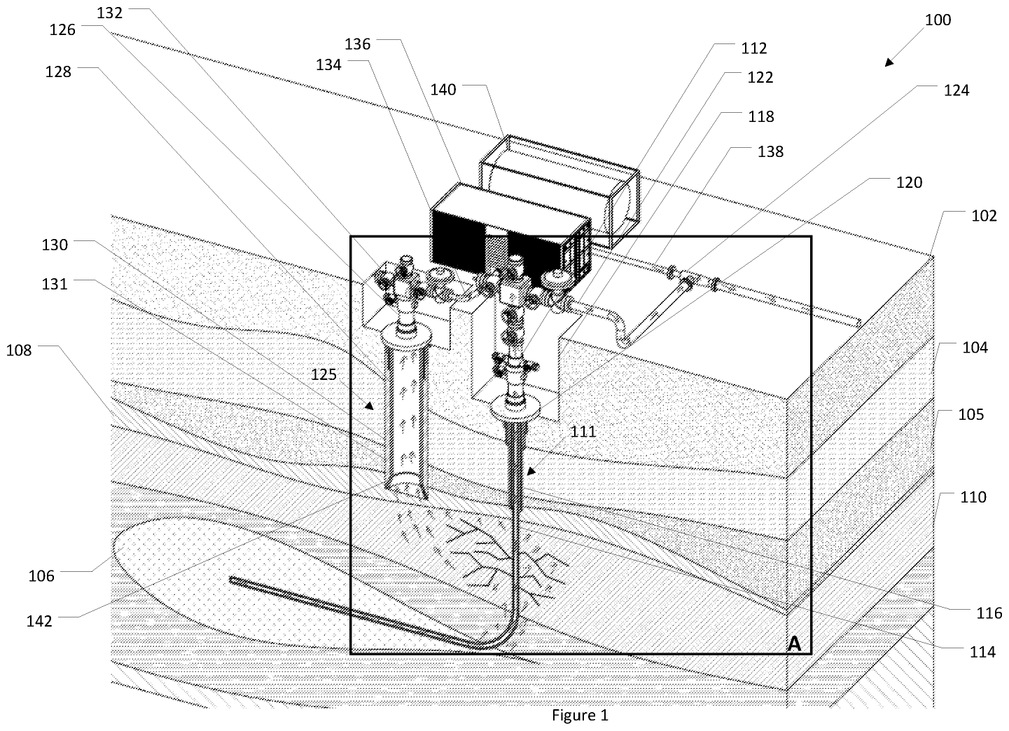

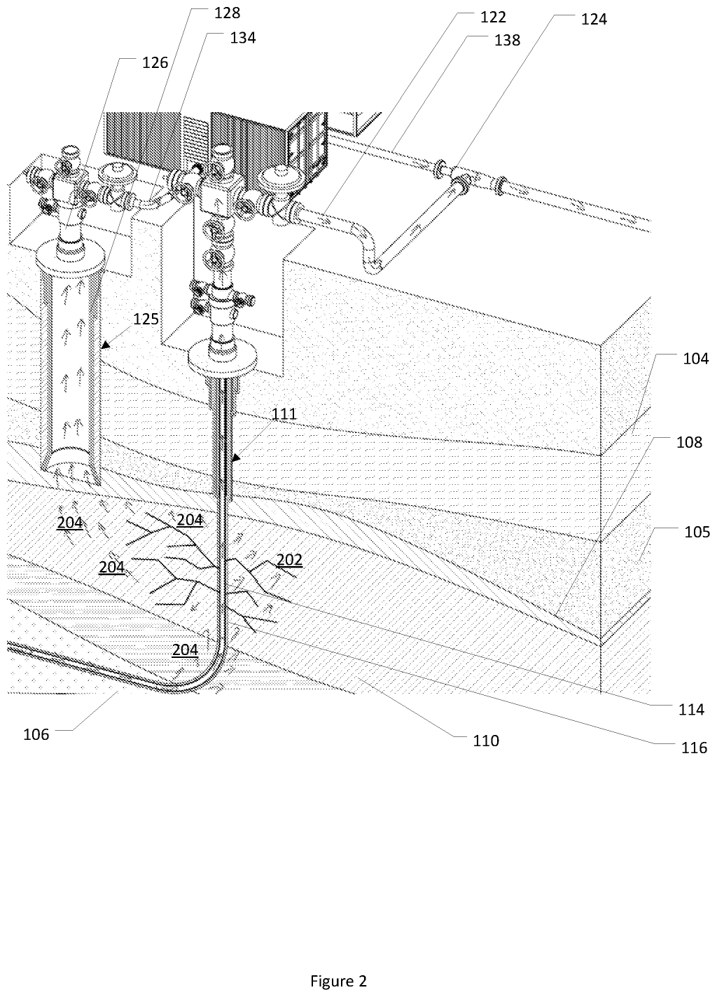

FIG. 1 illustrates a first embodiment of a system 100 for extracting contaminants released from an underground formation 102. The underground formation 102 includes a water permeable layer 104 overlying a production zone 106. In one example, the production zone 106 may include a hydrocarbon reservoir or a geothermal reservoir. Located below the water permeable layer 104 is an impermeable layer 105, a semi permeable layer 108 and an impermeable fractured layer 110 that also acts as a “cap rock” for the production zone 106. The system 100 includes a production wellbore 111 including a production well head 112 from which a production pipe 114 extends into a borehole 116 that passes through the water permeable layer 104 and towards the production zone 106. In order to secure the production pipe 114 to the rock wall of the borehole 116, and to prevent the leakage of gaseous contaminants cement may also be provided in the annulus surrounding the production pipe 114 and the borehole 116. In another embodiment, a plurality of production pipes may extend into a plurality of boreholes. It will also be appreciated that during drilling of the borehole, the diameter of the borehole and corresponding pipes gradually decreases with depth as shown in FIGS. 1-2.

The production well head 112 may be located at the surface or located in a sub-surface pit 118 as shown in FIG. 1. In the illustrated embodiment, a seal arrangement in the form of a well cap 120 may be provided between the production pipe 114 and the borehole 116 at an uppermost portion of the production well head 112. At the production well head 112, the gases are collected from the production pipe 114 by outlet pipe 122. Gases collected from the production wellbore 111 may be processed further downstream or stored in a storage tank (not shown) for transport and further processing.

A blowout preventer, choke line and kill line may also be provided at the production well head 112 in order to control and secure the integrity of the production wellbore and prevent the uncontrolled release of production fluids, such as shale gas, from the borehole 116.

During hydrocarbon extraction, geothermal well operation, or fracking activities some contaminants may leak from the production zone 106 and migrate upwards around the borehole 116. The flow of these contaminants may occur between the production pipe 114 and the cement, the cement and the surrounding borehole 116, and/or in the rock surrounding the borehole 116. It will be appreciated that the contaminants may be released and continue to migrate upwards along the production pipe 114 both during and after the hydrocarbon extraction, geothermal or fracking activities have ceased. It will also be appreciated that these contaminants may include excess methane gas (coal seam gas) or carbon dioxide gas.

In some circumstances, leakage of the contaminants may be due to poor sealing between the production pipe 114 and the surrounding rock wall of the borehole 116. In other circumstances, this may be due to deterioration or failure of the production pipe 114 or fracturing of the cement over time or due to the natural movements of the rock strata surrounding the borehole 116 or seismic activity. Alternatively, rock strata around the production pipe 114 may be fractured or permeable thereby creating a path for leaking gas. Some exemplary pathways of contaminant gas will be described in further detail in relation to FIG. 2.

Located in proximity to the production wellbore 111 is one or more remediation wellbores 125 for capturing contaminants escaping from the production zone 106. The one or more remediation wellbores 125 may be located at any suitable distance from the production wellbore 111, for example, to maintain the structural integrity of the production wellbore 111 during drilling of the one or more remediation wellbores 125. For example, a remediation wellbore 125 may be located at a distance of 2-4 meters, 4-8 meters or 8-12 meters from the production wellbore 111. Where a plurality of production wellbores exist, one or more remediation wellbores may be associated with each production wellbore. In another embodiment, a plurality of boreholes may be associated with a remediation wellbore 125.

The remediation wellbore 125 includes a remediation well head 126 from which a remediation pipe 128 extends into a borehole 130 that passes through the underground formation 102 towards the semi-permeable layer 108 located below water permeable layer 104 which may include an aquifer and impermeable layer 105. Cement 131 is provided in the annulus surrounding the remediation pipe 128 and the borehole 130.

The remediation wellhead 126 includes similar components as those described in relation to production wellhead 112 including a seal arrangement, a blowout preventer, choke line and kill line. The remediation wellhead 126 may also be located at the surface or in a subsurface pit. The remediation wellhead 126 may be located in the same subsurface pit 118 associated with the production wellbore 111 or be located in a separate subsurface pit 132 as shown, for example, in FIGS. 1-2.

The remediation wellbore 125 may be located at any suitable depth below the water permeable layer 104. In one example, the remediation wellbore 125 may be located at a depth of any of 1-25 meters, 1-20 meters, 1-15 meters, 1-10 meters or 1-5 meters below the water permeable layer 104. The depth below the water permeable layer is dependent on the type and depth of the geological layers of the geological formation. Typically the wellbore will extend through and below any impermeable layer 105 directly beneath the water permeable later into an underlying semi-permeable layer 108. It will be appreciated that by positioning the remediation wellbore 125 below the water permeable and impermeable layers 104 and 105, for example, in semi-permeable layer 108 or impermeable fractured layer 110, contaminants may be captured before they enter the water permeable layer 104.

The contaminants escaping from the production zone 106 rise upwards through the remediation wellbore 125 where they are captured at the remediation wellhead 126. In one embodiment, the contaminants captured at the remediation wellhead 126 are piped into outlet pipe 134 or a downstream line associated with the production pipe 114. In this embodiment, the contaminant gas from remediation wellbore 125 combines with the gases extracted from the production wellbore 111 and are directed downstream for further filtering, processing, transport and/or storage.

In another embodiment, the contaminants captured at the remediation wellhead 126 are directed to gas filtration assembly via outlet pipe 134. In the embodiment shown in FIG. 1, the gas filtration assembly is located in container 136 and connected to the vacuum source 124 via pipe 138. The contaminants may be extracted from the remediation wellbore 125 and the underlying rock formation 102, for example, semi permeable layer 108 and impermeable fractured layer 110 by the vacuum generated by the vacuum source 124. The vacuum created by the vacuum source 124 may also assist in directing the contaminants through the gas filtration assembly. The vacuum source 124 may provide a vacuum in the range of any of: 0.1-0.5 bar, 0.2-0.4 bar, 0.2-0.3 bar. In one embodiment, the vacuum source 124 is a Venturi ejector pump, with the vacuum being generated by the passage of coal seam gas from the production pipe through the outlet pipe 122, which entrains the filtered gas from the pipe 138.

In a further embodiment, a mechanical pump may be used in addition or as an alternative to assist in the extraction of filtered gases and/or contaminants. In one embodiment, the filtered gases may be piped to outlet pipe 122 associated with the production pipe 114 where they combine with the gases extracted from the production wellbore 111 for further processing downstream. In another embodiment, the filtered gases may be stored in a storage tank 140 for transport and further processing.

In some embodiments, one or more filtering assemblies may be provided in the remediation wellbore 125 to capture contaminants from the production zone 106 including solid, liquid and/or gaseous contaminants. Exemplary filter assemblies include those described in PCT application no PCT/AU2018/050353 (WO 2018/191783) filed on 19 Apr. 2018 and PCT application no PCT/AU2015/050271 (WO 2015/176139) filed on 22 May 2015, the contents of which are incorporated herein by reference in their entirety.

In some embodiments, the remediation wellbore 125 may be provided with a funnel 142 for directing contaminants into the remediation wellbore. In one embodiment, the funnel 142 is bolted or welded to the remediation pipe 128 prior to the remediation borehole 130 being drilled. Stiffeners may also provided between the lowermost portion of the remediation pipe 128 and the funnel 142 to reduce the vertical load of the remediation pipe 128. In one example, the funnel 142 of the remediation wellbore 125 has a diameter of 25-60 centimetres where it engages the remediation pipe 128 and a diameter of 1-1.5 meters, 1.1-1.3 meters, or approximately 1.2 meters at its opposite end. The remediation pipe 128 may also have a larger diameter than the production pipe 114. It will be appreciated that the larger diameter of the remediation pipe 128 may permit greater capture of contaminants from the underlying rock formation as it provides a less resistive escape path.

In one embodiment, the funnel 142 is a single component. In this embodiment which is shown in FIG. 1, the borehole is drilled at a diameter which is slightly larger than the outer diameter of the funnel 142, which allows the funnel and associated remediation pipe 128 to be lowered into the borehole 130, after which the gap between the borehole and the remediation pipe is filled with cement 131. In another embodiment, the funnel 142 includes a plurality of segments that are configured to be collapsed and expanded. In this embodiment, while the funnel 142 is being lowered through the borehole 130 during drilling, the funnel 142 is configured to be in the collapsed (i.e. closed) position. Once a desired location has been reached, the funnel 142 is expanded to an open position where it extends across the annular space or undercut cavity between the surrounding rock of the borehole 130 and the remediation pipe 128.

FIG. 2 illustrates exemplary pathways of contaminants that have escaped from production zone 106. The flow of these contaminants may occur between the production pipe 114 and the cement, the cement and the surrounding borehole 116, and/or in the rock surrounding the borehole, for example, in fractures 202 created in impermeable layer 110. In one example, contaminants released from the production zone 106 migrate along gaps and/or fractures created in the surrounding rock of the production wellbore as shown by reference numeral 204. The gases enter into impermeable fractured layer 110 and migrate into the fractures 202 and/or pore spaces of the rock. The gases will rise and migrate outwards from the production wellbore 111 through these fractures and/or pore spaces due to their lower density compared to the surrounding rock. The fugitive gases will continue to migrate through semi-permeable layer 108 towards remediation wellbore 125 due to the vacuum generated by the vacuum source 124 and the resultant easier escape path. Gases pooling beneath the impermeable later 105 will also tend to migrate to the base of funnel 142. The gases continue to rise upwards through the remediation pipe 128 where they are captured at remediation wellhead 126 for further processing at the gas filtration assembly located in the container 136.

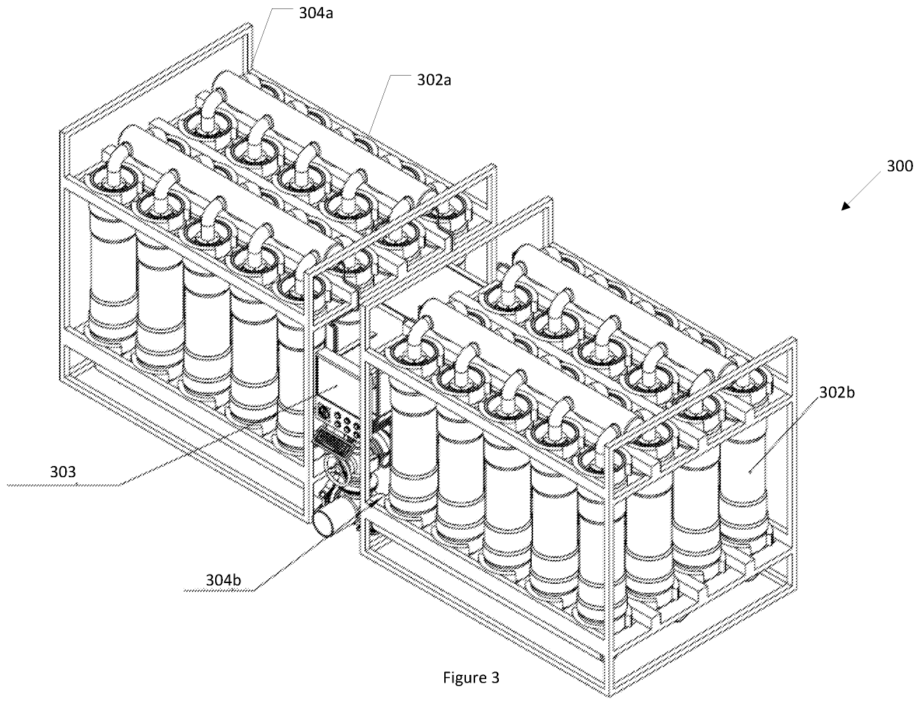

FIGS. 3-5 illustrate an exemplary gas filtration assembly 300. The gas filtration assembly 300 may be housed in any suitable container such as 20 or 40 ft shipping container 136. In one example, the container 136 and gas filtration assembly 300 are capable of being transported to a suitable storage and/or processing facility for further downstream processing. In another example, the container 136 is permanently located downstream from remediation wellhead 126. The gas filtration assembly 300 may be located at the surface, located underground or located in a sub-surface pit 132 as shown in FIGS. 1-2.

The gas filtration assembly 300 includes one or more banks of filter modules whereby each bank has one or more filtration stages with each stage including one or more filter modules connected in series by lower and upper manifolds. In the embodiment shown in FIG. 3, the gas filtration assembly 300 includes a first bank 302a and a second bank 302b of filter modules. Each bank of filter modules is supported by a frame 304a-b, which may assist in removing the bank of filter modules from the surrounding container 136. Each filter module is connected to a control system 303 including a controller and display for controlling the strength of the vacuum provided by the vacuum source 124 and to monitor and display the condition of each filter module, as well as the type and concentration of contaminant gases.

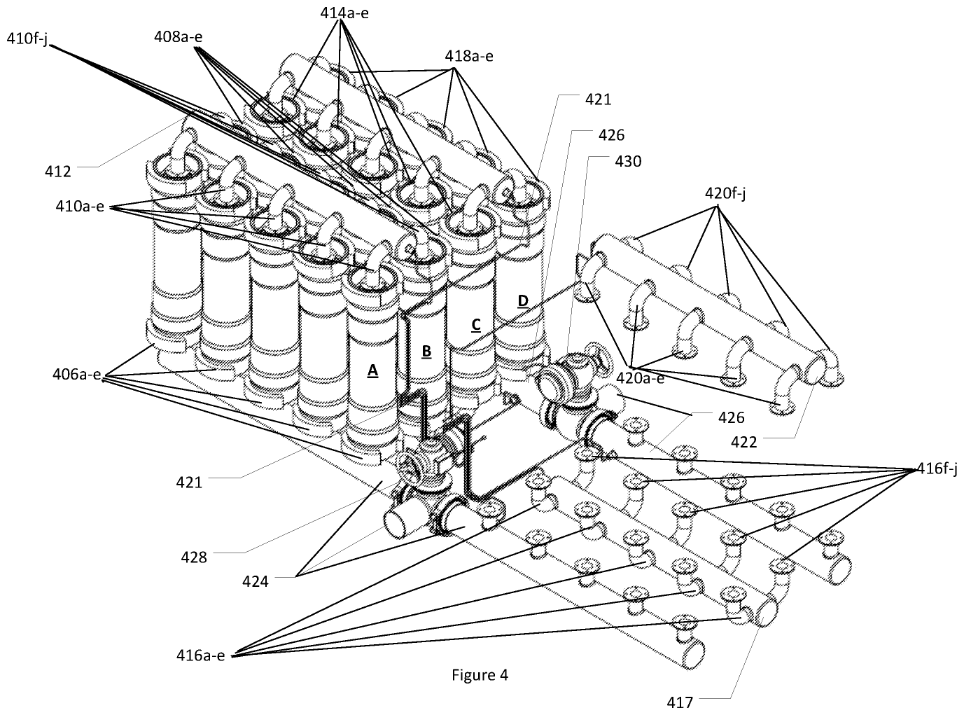

Referring to the embodiment shown in FIG. 4, the first and second bank 302a,b of filter modules each include four filtration stages indicated by numerals A-D where each filtration stage includes five filter modules. Filter modules 406a-e of the first filtration stage (indicated by reference “A” in FIG. 4) are serially connected to filter modules 408a-e of the second filtration stage (indicated by reference “B” in FIG. 4) by manifolds 410a-j joined to central conduit 412. Filter modules 408a-e of the second filtration stage are serially connected to filter modules 414a-e of the third filtration stage (indicated by reference “C” in FIG. 4) by manifolds 416 a-j joined to central conduit 417. In turn, filter modules 414a-e of the third filtration stage are serially connected to filter modules 418a-e of the fourth filtration stage (indicated by reference “D” in FIG. 4) by manifolds 420a-j joined to central conduit 422.

The inlet of each filter module of the first filtration stage may be connected to an inlet pipe 424 for receiving contaminant gas extracted from the remediation wellbore 125 and the outlet of each filter module of the last filtration stage may be connected to an outlet pipe 426 for transmitting filtered gases to pipe 138.

Inlet pipe 424 may be provided with a valve diverter 428 for selectively diverting contaminant gases extracted from the remediation wellbore 125 to each bank 302a,b of filter modules. In the example shown in FIG. 4, valve diverter 428 is located along inlet pipe 424 and may selectively divert contaminant gases from the first bank 302a to the second bank 302b of filter modules. Outlet pipe 426 may also be provided with a valve diverter 430 for selectively diverting filtered gases from each filter bank 302a,b to pipe 138. In one example, the valve diverter 428 is used when the filter modules of the first bank 320a are saturated with contaminants and need replacing, so that the path of incoming unfiltered gas may be redirected to the second filter bank 302b, which may be unsaturated, or partially saturated, with contaminants.

The filter modules of each filtration stage may be provided with chemical and/or physical filter media for filtering gaseous contaminants. The type of physical and/or chemical filter media located in the filter modules may depend on the type of contaminants leaking from the production zone and/or the stage of filtration. In one example, the filter modules may house a bed of activated carbon to remove contaminants using chemical absorption. In another example, the filter modules may house a bed of zeolite such as zeolite clinoptilolite to remove contaminants, for example, ammonium, iron and manganese. In another example, the filter modules may house a bed of chemicals to remove contaminants such as benzene, toluene, xylene and volatile organic compounds using chemical reactions. In another example, filter modules of the first and second filtration stages are provided with a bed of activated carbon, while the filter modules of the third and fourth filtration stages are provided with a bed of zeolite. Additionally or alternatively, the housing of each filter module may be provided with one or more apertured structures to assist in replacing the chemical and/or physical media within the housing. In one example, the apertured structure may be a rigid basket and in another example the apertured structure may be a mesh bag suitably shaped and dimensioned to reside within the filter module housing.

One or more sensors may be coupled to one or more of the filter modules 406a-e, 408a-e, 414a-e and 418a-e, manifolds 410a-j, 416a-j and 420a-j and/or central conduits 412, 417, 422 for detecting one or more conditions of the filter module and/or the surrounding environment. The one or more sensors are connected to the control system 303 via sensor lines 421. In one example, each filter module 406a-e, 408a-e, 414a-e and 418a-e is provided with a first and second sensor for detecting the respective composition and concentration of the gases prior to, and post, filtration. In another example, each filter module may be provided with a sensor to detect the saturation of the filter media and provides an indication of when the filter module requires replacing. In another example, each filter module may be provided with a sensor to detect whether a user has attempted to remove the filter module from the respective filter bank or access the contents of the module.

In embodiments where two or more banks of filter modules are used, each bank of filter modules may be releasably connected to each other. In the example, shown in FIG. 4, the first bank 302a of filter modules are releasably connected to the second bank 302b of filter modules. Releasable connection of the banks of filter modules may permit the removal and replacement of the bank of filter modules when the filter modules become saturated with contaminants.

The filter modules may be any suitable shape and arranged in any suitable configuration to form a filter bank. In the embodiments shown in FIGS. 3-5, each filter module includes a cylindrical housing and are arranged in a parallel arrangement in banks 302a,b.

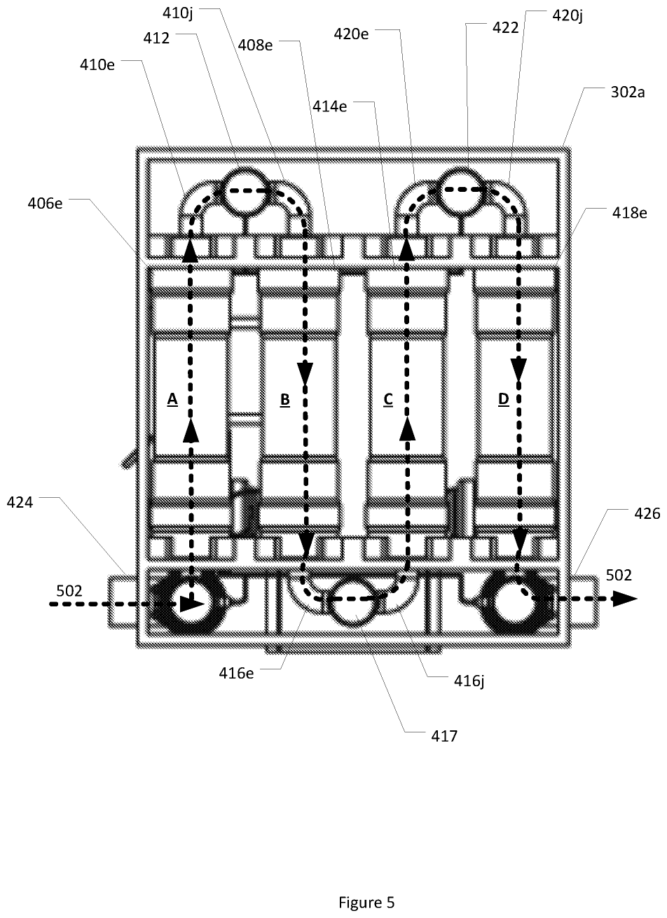

FIG. 5 illustrates an exemplary pathway 502 of contaminant gas through filtration bank 302a. The vacuum source 124 extracts the contaminant gas captured at the remediation wellbore 125 through pipe 134 and into inlet 424 for filtration by filtration bank 302a. The contaminant gas is sequentially filtered through each filtration stage where it undergoes filtration by the chemical and/or physical filter media located in the filter modules. For example, the contaminant gas enters filter module 406e of the first filtration stage (indicated by reference “A” in FIG. 5), travels through manifolds 410e,j and central pipe 412 before entering filter module 408e of the second filtration stage (indicated by reference “B” in FIG. 5). The partially filtered contaminant gas then enters manifolds 416e,j, central pipe 417 and filter module 414e of the third filtration stage (indicated by reference “C” in FIG. 5) followed by manifolds 420e,j, central pipe 422 and filter module 418e of the fourth filtration stage (indicated by reference “D” in FIG. 5). The vacuum source 124 extracts the filtered gases from the fourth filtration stage through outlet pipe 426 and along pipe 138. These filtered gases may be stored in storage tank 140 or pumped downstream for further processing, transport and/or storage. Additionally or alternatively, they may be added to the fluids and/or gases extracted from the production wellbore 111.

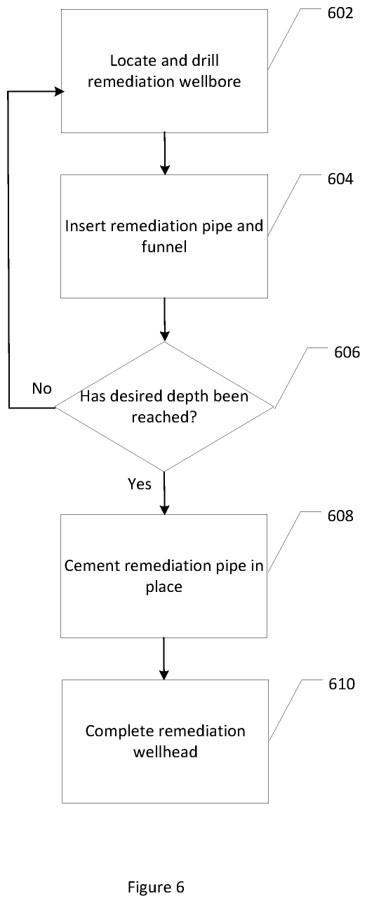

The operation of system 100 for capturing contaminants released from an underground formation 102 will now be described with reference to FIG. 6. It will be appreciated that some of these steps may be performed in a different sequence without departing from the general concept of the present disclosure.

At step 602, a suitable location of the remediation borehole 130 is determined that is in proximity to the production wellbore 111 and the borehole 130 is drilled from the surface to a desired depth below the water permeable layer 104 based on the above-described factors. The depth may be determined using GIS mapping data, as well as well drill monitor and depth tracking sensors. In some embodiments, the remediation borehole 130 may be drilled after the production wellbore 111 has been completed, for example, while the production wellbore is in production or after it has been abandoned. In some embodiments, the remediation borehole 130 may be drilled during completion of the production wellbore 111.

At step 604, the remediation pipe 128 and funnel 142 are inserted through the borehole 130. It will be appreciated that drilling of the remediation borehole 130 and insertion of the remediation pipe 128 may be completed together, for example, using Casing-while-Drilling techniques or separately. In some embodiments, reverse circulation mud rotary drilling may be used to drill the borehole. Reverse circulation drilling may minimise or avoid the risk of an explosion during drilling in an environment where there is methane gas. The remediation pipe 128 may be completed separately or together with reverse circulation drilling.

It will also be appreciated that the remediation borehole 130 is drilled at a greater diameter than the remediation pipe 128 and funnel 142. In one example, the borehole 130 is drilled with a diameter of approximately 1.5 meters or less and a remediation pipe 128 having a diameter of approximately 60 centimetres and a funnel 142 having a maximum diameter of 1.2 meters is used.

Once the desired depth below the water permeable layer 104 has been reached at step 606, the remediation pipe is cemented in place (step 608). In one example, the desired depth is when the funnel 142 is located at the transition between the impermeable layer 105 and underlying semi-impermeable layer 108. In another example, the desired depth is when the funnel 142 is located approximately 1-5 meters below the transition between the water permeable layer 102 and the underlying impermeable layer 105. Steps 602-606 may be repeated until a desired depth below the water permeable layer 104 has been reached.

At step 610, the remediation wellhead 126 is completed. Completion of the remediation wellhead 126 may include sealing the remediation borehole 130 and attaching a blowout preventer, a choke line and a kill line, installing the filtering assembly and connecting the remediation wellhead 126 to the filtering assembly 136 and vacuum source 124.

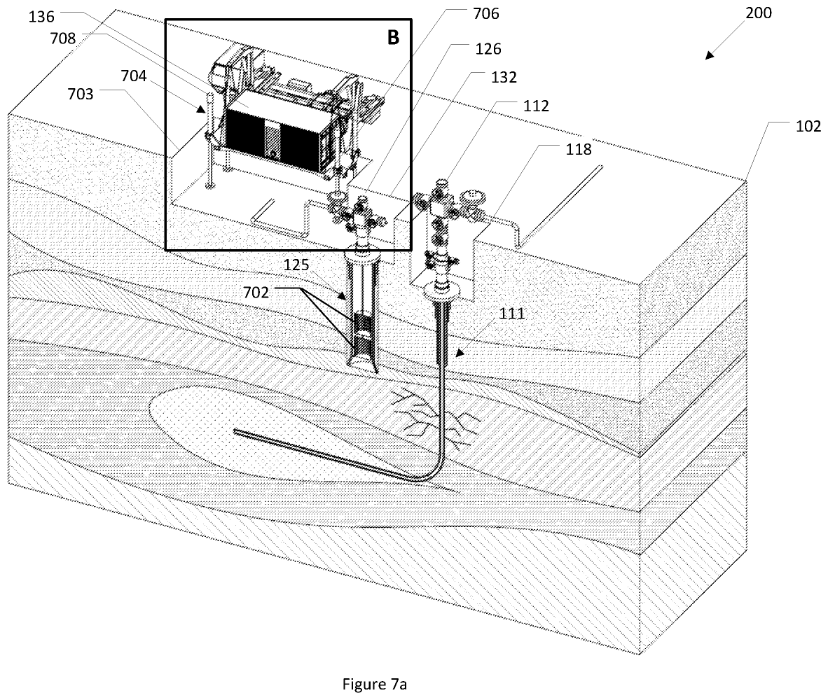

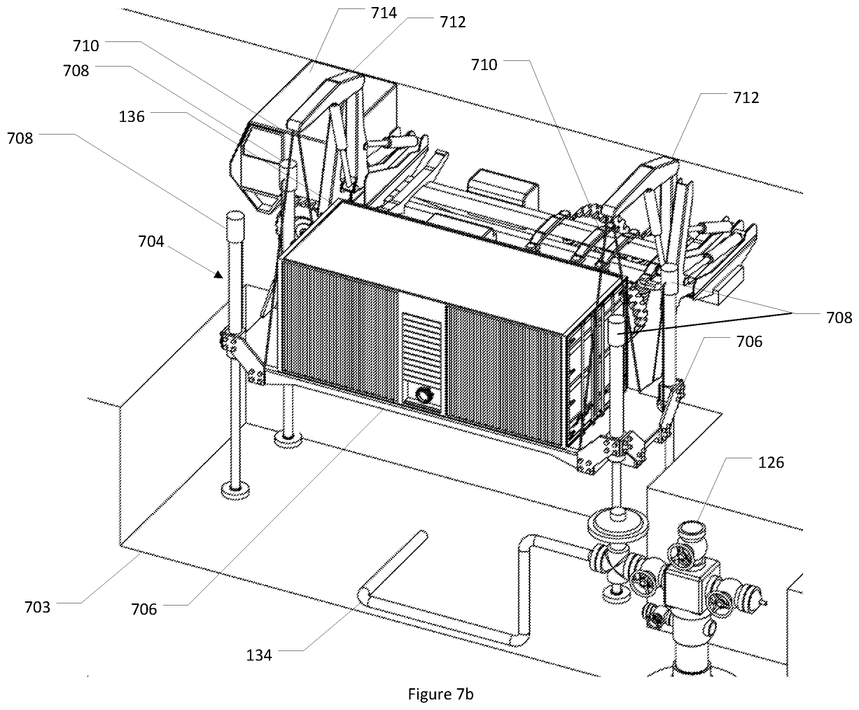

FIGS. 7a-b illustrates a second embodiment of a system 200 for extracting contaminants released from an underground formation 102. The underground formation 102 and system 200 include a similar structure and components as system 100 and underground formation 102 illustrated and described with reference to FIGS. 1-2, except that one or more filtering assemblies 702 are provided in the remediation wellbore 125 and that container 136 is located in a sub-surface pit 703. In some embodiments, the container 136 may be located in the same subsurface pit 118, 132 as the production wellhead 112 or the remediation wellhead 126.

In the embodiments shown in FIGS. 7a-b, a lifting and lowering system 704 is provided in the sub-surface pit 703 for lifting and lowering the container 136 from/into the sub-surface pit. The lifting and lowering system 704 may be coupled to a platform 706 for supporting the container 136 and includes one or more hydraulic or pneumatic rams 708 that include a piston rod and a cylinder. In some embodiments, the platform 706 may include one or more apertures (not shown) for engaging one or more hooks (not shown) or ropes (710) of a loading system 712 of a transport vehicle 714. In some embodiments, the lifting and lowering system 704 may be provided at the surface for lifting and lowering the container 136 to/from the transport vehicle 714. In some examples, the lifting and lowering system may be any one of: a hydraulic lift, a hydraulic lift table, a scissor lift, an electric hoist, a gantry crane, a jib crane or an overhead crane.

In some embodiments, when the gas filtration assembly 300 located in the container 136 becomes saturated with contaminants, pipes 134 and 138 are disconnected from respective inlet 424 and outlet 426 pipe of the gas filtration assembly and the container 136 is lifted from the sub-surface pit 703 by the lifting and lowering system 704 onto a transport vehicle 714 for downstream processing and storage. A replacement container, including a replacement gas filtration assembly 300, may then be lowered into the sub-surface pit 714 from a transport vehicle by the lifting and lowering system 704 and pipes 134 and 138 are connected to the respective inlet 424 and outlet pipe 426 of the gas filtration assembly 300.

It will be understood that the invention disclosed and defined in this specification extends to all alternative combinations of two or more of the individual features mentioned or evident from the text or drawings. All of these different combinations constitute various alternative aspects of the invention.

1. A system for contaminant extraction from a contaminated region of a borehole including a production pipe extending from a surface of the earth through a water permeable layer and into an underlying production zone, the system comprising: a side remediation borehole located proximate the borehole and extending through the water permeable layer towards the production zone, the side remediation borehole including a remediation pipe; and
a vacuum source in fluid communication with the side remediation borehole, the vacuum source being configured to extract gaseous contaminants from the side remediation borehole and the region of the borehole.

2. The system of claim 1, further comprising an outlet of the remediation pipe in direct or indirect fluid communication with an outlet pipe of the production pipe to combine the gaseous contaminants with gases extracted from the production pipe for downstream filtering and/or processing.

3. The system of claim 1, further comprising a gas filtration assembly in fluid communication with the side remediation borehole and configured to filter gaseous contaminants extracted from the side remediation borehole and the region of the borehole.

4. The system of claim 3, wherein the gas filtration assembly includes a series of gaseous contaminant filter modules providing multi-stage filtering.

5. The system of claim 3, wherein the system includes a filtered gas storage system in fluid communication with a filtered gas outlet from the gas filtration assembly.

6. The system of 3, wherein the series of gaseous contaminant filter modules are arranged in two or more releasably connected filter banks.

7. The system of 4, wherein the multi-stage filtering provided by the series of gaseous contaminant filter modules involves four filtration stages.

8. The system of claim 3, wherein the gas filtration assembly is located in a relocatable container.

9. The system of claim 8, wherein the relocatable container is coupled to a lifting and lowering system for lifting and lowering the relocatable container from or into a subsurface pit.

10. The system of claim 1, wherein the remediation pipe includes a lowermost funnel for directing gaseous contaminants migrating from the production zone towards the remediation pipe.

11. The system of claim 1, wherein the vacuum source comprising a venturi pump driven by gases from the production pipe.

12. A method for contaminant extraction from a contaminated region of a borehole including a production pipe extending from a surface of the earth through a water permeable layer and into an underlying production zone, the method comprising:
providing a side remediation borehole located proximate the borehole and extending through the water permeable layer towards the production zone, the side remediation borehole including a remediation pipe;
coupling a vacuum source to the side remediation borehole, the vacuum source being configured to extract gaseous contaminants from the side remediation borehole and the region of the borehole.

13. The method of claim 12, further comprising extracting gaseous contaminants from an outlet of the remediation pipe in direct or indirect fluid communication with an outlet pipe of the production pipe to combine the gaseous contaminants with gases extracted from the production pipe for downstream filtering and/or processing.

14. The method of claim 13, further comprising extracting the gaseous contaminants through a gas filtration assembly in fluid communication with the side remediation borehole and the vacuum source, wherein the gas filtration assembly is configured to filter gaseous contaminants extracted from the side remediation borehole and the region of the borehole.

15. The method of claim 14, wherein the gas filtration assembly includes a series of gaseous contaminant filter modules providing multi-stage filtering.

16. The method of claim 14, wherein the method further comprises coupling a filtered gas storage system to a filtered gas outlet from the gas filtration assembly.

17. The method of claim 15, wherein the series of gaseous contaminants are arranged in two or more releasably connected filter banks.

18. The method of claim 15, wherein the multi-stage filtering provided by the series of gaseous contaminant filter modules involves four filtration stages.

19. The method of claim 14, wherein the gas filtration assembly is located in a relocatable container.

20. The method of claim 12, wherein the remediation pipe includes a lowermost funnel for directing gaseous contaminants migrating from the production zone towards the remediation pipe.
